(19) United States
(12) Patent Application Publication
(10) Pub. No.: US 2014/0355656 A1
(43) Pub. Date: Dec. 4, 2014

(54) OPERATION METHOD OF VEHICLE SYSTEM

(71) Applicant: ASUSTeK COMPUTER INC., TAIPEI (TW)

(72) Inventors: Fou-Ming LIOU, TAIPEI (TW); Yen-Hwa CHEN, TAIPEI (TW)

(73) Assignee: ASUSTeK COMPUTER INC., TAIPEI (TW)

(21) Appl. No.: 14/283,237

(22) Filed: May 21, 2014

Related U.S. Application Data
(60) Provisional application No. 61/830,648, filed on Jun. 4, 2013.

(30) Foreign Application Priority Data
Jan. 14, 2014 (CN) 201410015548.3

(51) Int. Cl. H04B 7/26; G06F 3/041

(52) U.S. Cl. CPC H04B 7/26; G06F 3/041
USPC 375/219

(57) ABSTRACT

An operation method of a vehicle system, the vehicle system includes a host and cooperates with a mobile device. The operation method includes: connecting the mobile device and the host wirelessly. wherein the mobile device is detachably connected to the host; receiving a touch input at the mobile device to generate a wireless control signal; receiving the wireless control signal at the host to make the host operate according to the wireless control signal; transmitting an image data to the mobile device wirelessly; and displaying the image data at the mobile device.

### CROSS-REFERENCE TO RELATED APPLICATION

This application claims the priority benefit of U.S. provisional application Ser. No. 61/830,648, filed on Jun. 4, 2013 and CN application serial No. 20141001.55483, filed on Jan. 14, 2014. The entirety of the above-mentioned patent application is hereby incorporated by reference herein and made a part of specification.

### BACKGROUND OF THE INVENTION

### Field of the Invention

With the development of automobile industry, the vehicle system is multifunction. Recently years, a common vehicle system usually integrates with a host and a touch panel, the touch panel is fixedly built in the host to allow users to operate the host directly via a Graphical User Interface (GUI) at the touch panel.

However, when the touch panel is built in the host, not only the general function (such as navigation and music play) needs to be controlled via the host, the signal from the touch panel also needs to be processed by the host, and thus the work efficiency is low. Moreover, if software or hardware needs to be updated, the fixed touch panel and the host in the vehicle system are not easily to be updated.

Moreover, since the service environment of the vehicle touch panel is usually specific, the vehicle touch panel needs to suffer the high temperature (such as sunshine), and the specification of the touch panel should conform to the vehicle system. Consequently, the cost of the vehicle touch panel is usually higher than a general touch panel.

### BRIEF SUMMARY OF THE INVENTION

An operation method of a vehicle system is provided to simplify the connection and the operation between the host and a display device, which can make the configuration of the host and the display device more flexible.

An operation method of a vehicle system is provided. The operation method includes: connecting the mobile device and the host wirelessly, the mobile device is detachably connected to the host; receiving a touch input at the mobile device to generate a wireless control signal; receiving the wireless control signal at the host to make the host operate according to the wireless control signal; transmitting an image data to the mobile device wirelessly; and displaying the image data at the mobile device.

Images received or stored by the host are displayed at the mobile device of a detachably host via wireless connection or the Bluetooth connection, and the host is controlled by the GUI at the touch panel of the mobile device.

The display function is executed via the mobile device which is independent front the host, and thus the cost of the vehicle system can be reduced.

### BRIEF DESCRIPTION OF THE DRAWINGS

FIG. 1A is a schematic diagram showing a vehicle system in an embodiment;

FIG. 1B is a schematic diagram showing a vehicle system in another embodiment;

FIG. 2 is a block diagram showing a circuit of a host and a mobile device of a vehicle system in an embodiment; embodiment; and

FIG. 4 a block diagram showing a circuit of a host and a mobile device of a vehicle system in another embodiment.

### DETAILED DESCRIPTION OF THE EMBODIMENTS

These and other features, aspects, and advantages of the present invention will become better understood with regard to the following description, appended claims, and accompanying drawings. However, the invention is not limited to the embodiments. The description of the operation of components is not used for limiting the execution sequence. Any equivalent device with the combination according to the disclosure of the invention is in the scope of the invention. The components shown in figures are not used for limit the size or the proportion. The same or similar number donates the same or similar component,

The terms “connected” can represent that two or more components are contacted physically or electronically, and the contact therebetween may be direct indirect, and it also may represent that two or more components operate or act with each other, which is not limited herein.

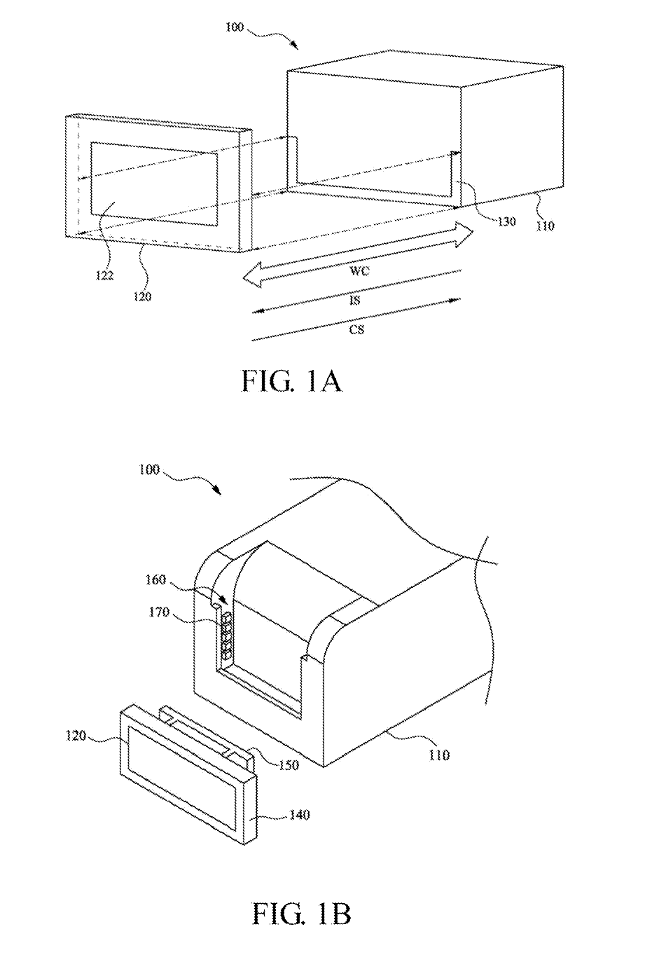

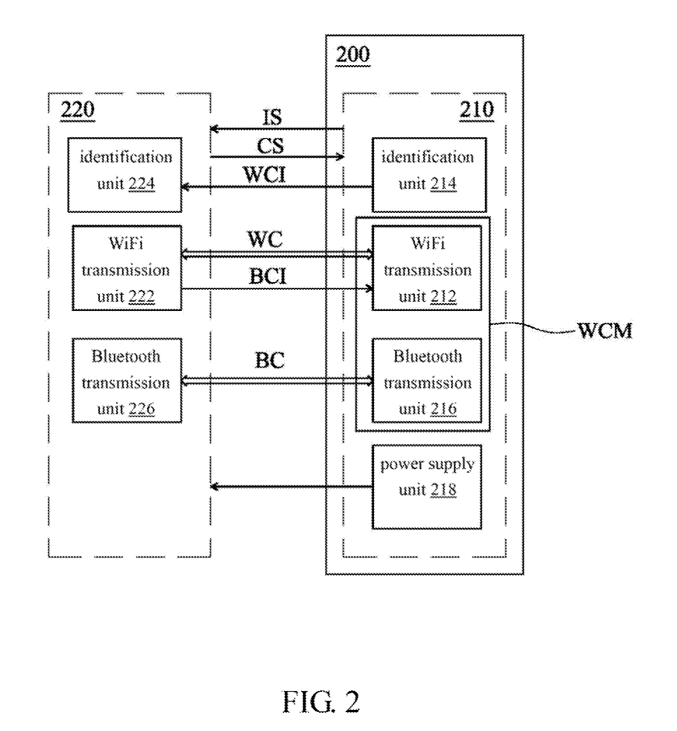

FIG. 1A is a schematic diagram showing a vehicle system in an embodiment. As shown in FIG. 1A, the vehicle system 100 includes a host 110. The host 110 cooperates with a mobile device 120, and the mobile device 120 includes a touch screen 122.

The host 110 is detachably and wirelessly connected to the mobile device 120, and a wireless connection WC is built. In an embodiment, when the mobile device 120 is disposed to the host 110, a wireless connection WC can be built between the mobile device 120 and the host 110.

In an embodiment, as shown in FIG. 1A, the vehicle system 100 further includes a fixing unit 130. The mobile device 120 is detachably connected to the host 110 via the fixing unit 130.

For example, the fixing unit 130 may be a bracket. The bracket is disposed at a side of the host 110 (as shown in FIG. 1A), it allows the mobile device 120 to be selectively placed at the bracket, and then the mobile device 120 can be disposed at one side of the host 110 or detached from one side of the host 110.

Moreover, the fixing unit 130 also may be a magnet. The magnet is disposed at one side of the host HO and one side of the mobile device 120, respectively, when the mobile device 120 gets close to the host 110, the magnets at the side of the host 110 and the side of the mobile device 120 are attracted by each other to make the mobile device 120 fixed to the host 110.

Type of the fixing unit 130 is not limited to the description in the embodiment above and can be make variously, which is not limited herein.

When the wireless connection WC is built between the host 110 and the mobile device 120, the host 110 can wirelessly transfer the image data IS to the mobile device 120 via wireless connection WC with the mirroring technology, and then the image data IS can be displayed at the mobile device 120.

After the wireless connection WC is built between the host 110 and the mobile device 120, the mobile device 120 transmits the wireless control signal CS to the host 110 via the back channel technology according to the wireless control signal CS generated by the touch input at the touch screen 122, the host 110 receives the wireless control signal CS and operates according to the wireless control signal CS.

The touch input can be generated by operating at a graphical user interface (GUI) of the touch screen 122. For example, if a user touches a music icon at the touch screen 122, the mobile device 120 generates a wireless control signal CS to the host 110 to make the host 110 execute the music play function. When other icons of the touch screen 122 are touched (such as volume or music menu), the mobile device 120 generates a corresponding wireless control signal CS to the host 110 to make the host 110 execute other corresponding functions (such as volume adjustment or music play).

FIG. 1B is a schematic diagram showing a vehicle system in another embodiment. As shown in FIG. 1B. the vehicle system 100 includes a fixing member 140, a back cover 150 and a runner 160.

The fixing member 140 is a frame for holding the mobile device 120. The size of the fixing member 140 can be designed according to a specific mobile device 120.

The back cover 150 is used for connecting the host 110 with the fixing member 140. Two sides of the back cover 150 are placed at the runner 160 to make the mobile device 120 which is held at the fixing member 140 connected to the host 110.

Moreover, the runner 160 includes a damp 170 therein, the damp 170 is used to reduce the vibration when the back cover 150 is inserted to the runner 160, so as to reduce the influence on the host due to the vibration.

The host 110 includes a power transmitting unit (not shown), and the back cover 150 includes a power receiving unit (not shown). When the mobile device 120 is fixed to the fixing member 140, and the fixing member 140 is connected to the host 110 via the back cover 150 and the runner 160, the mobile device 120 receives the power from the power transmitting unit via the power receiving unit, and then the mobile device 120 is wirelessly charged.

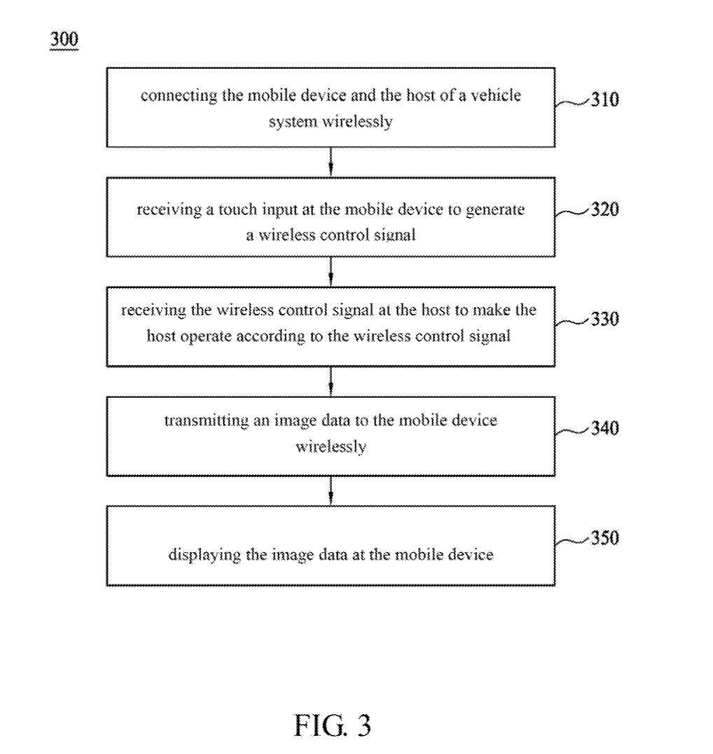

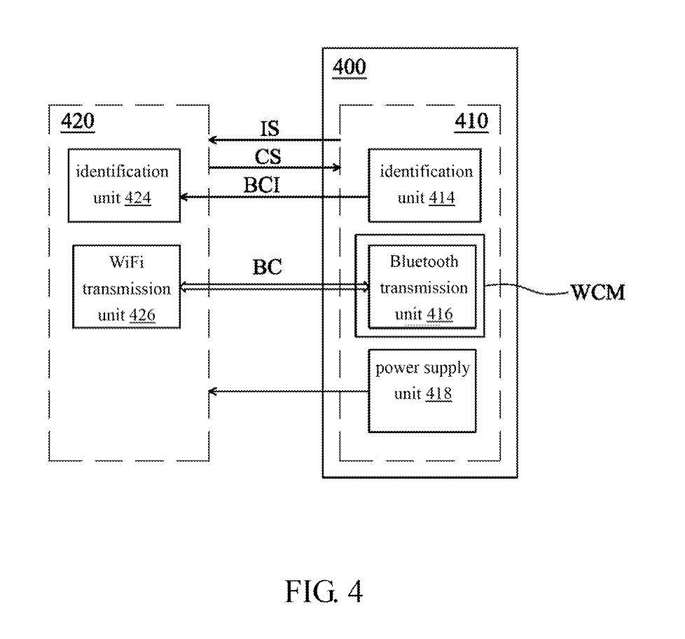

FIG. 2 is a block diagram showing a circuit of a host and a mobile device of a vehicle system in an embodiment. As shown in FIG. 4, the vehicle system 200 includes a host 210. The host 210 cooperates with the mobile device 220. The host 210 can wirelessly communicate with the mobile device 220 via the wireless connection WC. The host 210 in this embodiment can be used at the vehicle system 100 in FIG. 1A, which is not limited herein. The wireless connection WC can be WiFi connection, the mobile device 120 may be a tablet computer, which is not limited herein.

In an embodiment, the host 210 and the mobile device 220 includes identification units 214 and 224. The identification unit 214 identifies the mobile device 220 and transmits wireless connection information WCI to the identification unit 224 of the mobile device 220, and thus the identification unit 224 can read wireless connection information WCI from the identification unit 214.

The identification units 214 and 224 can be achieved by the Near Field Communication (NFC) technology or the Bluetooth technology. If the identification units 214 and 224 are achieved by the Near Field Communication (NFC) technology, the identification unit 214 may be a NFC Tag, and the identification unit 224 may be a NFC Reader. When the identification units 214 and 224 are achieved by the Bluetooth technology, the identification unit 214 may be a Bluetooth transmitter, the identification unit 224 may be a Bluetooth receiver.

The host 210 includes a wireless communication module WCM, and the wireless communication module WCM further includes a WiFi transmission unit 212. The mobile device 220 further includes a WiFi transmission unit 222. The wireless connection WC is built between the WiFi transmission unit 212 and the WiFi transmission unit 222 of the mobile device 220 according to the wireless connection information WCI (such as a WiFi name and password, or WiFi access point information). The WiFi transmission units 212 and 222 may be a WiFi module or a WiFi circuit, which is not limited herein.

In the embodiment, after the identification unit of the host and the identification unit of the mobile device identify each other, and wireless connection is built therebetween, however, whether to identify before the wireless connection can be determined by the practical requirements, which is not limited herein.

The wireless communication module WCM further includes a Bluetooth transmission unit 216. After the host 210 and the mobile device 220 identify each other to build the wireless connection WC, the WiFi transmission unit 212 receives the Bluetooth connection information BCI from the mobile device 220 via the wireless connection WC, so as to build the Bluetooth connection BC between the Bluetooth transmission unit 216 of the host 210 and the Bluetooth transmission unit 226 of the mobile device 220 according to the Bluetooth connection information BCI. As a result, audio data between the host 210 and the mobile device 220 can be transferred via the Bluetooth connection BC. In addition, the Bluetooth transmission units 216 and 226 also can be integrated to the identification units 214 and 224, respectively.

The Bluetooth connection information BCI received by the WiFi transmission unit 212 of the host 210 can be directly transmitted to the Bluetooth transmission unit 216, or the Bluetooth connection information BCI from the WiFi transmission unit 212 is first received by a processing unit (not shown), and then it is transferred to the Bluetooth transmission unit 216.

The host 210 further includes a power supply unit 218. The power supply unit 216 wirelessly charges the mobile device 220 when the host 210 is wirelessly connected or matches with the mobile device 220. The wireless charging can be executed independently, or it is executed when the wireless connection WC and/or the Bluetooth connection BC is maintained between the host 210 and the mobile device 220 and the image and/or audio data is transferred.

FIG. 3 is a flow chart showing an operation method of a vehicle system in an embodiment. The operation method of the vehicle system 300 can be achieved by the vehicle system 200 and the mobile device 220 in FIG. 2, which is not limited herein. The operation method of the vehicle system 300 is illustrated accompanying with FIG. 2 and FIG. 3.

First, wireless connection is built between the mobile device 220 and the host 210 of the vehicle system 200 (step 310). Then, the touch input at the mobile device 220 is received to generate the wireless control signal CS (step 320). The wireless control signal CS is received at the host 210 to make the host 210 operate according to the wireless control signal CS (step 330). The host 210 transfers the image data IS to the mobile device 220 wirelessly via the wireless connection WC (step 340). The image data IS is displayed at the mobile device 220 (step 350).

In an embodiment, the host 210 identifies the mobile device 220 before the mobile device 220 and the host 210 connected wirelessly.

In an embodiment, the host 210 can identify the mobile device 220 via the NFC technology or the Bluetooth technology.

In an embodiment, after the host 210 identifies the mobile device 220, the identification unit 214 wirelessly transfers the wireless connection information WCI to the identification unit 224 to make the host 210 and the mobile device 220 build wireless connection WC according to the wireless connection information WCI, and then the mobile device 220 can execute multiple functions according to the operation of the host 210 (such as Rear View Camera, laser CD play, or digital television play).

For example, when reversing a car, the mobile device 220 displays the surrounding road condition or the router guided by the host 210, or the icon representing the disk is touched to make the mobile device 220 play audio. When the mobile device 220 plays audio, the resolution f outputted images and the volume of the audio/video of the mobile device 220 can be adjusted via the GUI.

In an embodiment, the wireless connection information includes Bluetooth connection information, WiFi connection information or the combination.

In an embodiment, when the host 210 is connected to the mobile device 220, the power supply unit 218 wirelessly charges the mobile device 220.

The sequence of steps in the above embodiment is not limited, and some steps even can be omitted. For example, after the steps of wirelessly connecting the mobile device 220 and the host 210 of the vehicle system 200 (step 310), the host 210 can wirelessly transmit the image data IS to the mobile device 220 via the wireless connection WC (step 340), and then the image data IS is displayed at the mobile device 220 (step 350).

In another embodiment, after connecting the mobile device 220 and the host 210 of the vehicle system 200 wirelessly (step 310), the host 210 wirelessly transfers the image data IS to the mobile device 220 via the wireless connection WC (step 340). Then, the image data IS is displayed at the mobile device 220 (step 350). The touch input is received at the mobile device 220 to generate the wireless control signal CS (step 320). Finally, the wireless control signal CS is received by the host 210 to make the host 210 operate according to the wireless control signal CS (step 330).

In other words, unless specifically stated, the sequence of the steps in above embodiments can be adjusted, executed, or partly executed at the same time, and the method is no limited to the embodiment in FIG. 3.

FIG. 4 a block diagram showing a circuit of a host and a mobile device of a vehicle system in another embodiment A vehicle system 400 includes a host 410. The host 410 cooperates with the mobile device 420. The host 410 mainly wirelessly communicates with the mobile device 420 via Bluetooth connection BC. The host 410 can be applied at the vehicle system 100 in FIG. 1A, which is no limited herein. The mobile device 420 may be a mobile phone, which is not limited herein.

The host 410 includes an identification unit 414 and a wireless communication module WCM, the wireless communication module WCM includes a Bluetooth transmission unit 416. The mobile device 420 includes an identification unit 424 and a Bluetooth transmission unit 426. The identification unit 414 identifies the mobile device 420 and wirelessly transmits the Bluetooth connection information BCI (such as secure simple pairing (SSP) of the Bluetooth) to the identification unit 424, the identification unit 424 reads the Bluetooth connection information BCI from the identification unit 414. After the host 410 identifies the mobile device 420, the Bluetooth transmission unit 426 builds the Bluetooth connection BC with the Bluetooth transmission unit 416 according to the Bluetooth connection information

Practically, the identification units 414, 424 may be achieved by the Near Field Communication (NFC) technology or the Bluetooth. if the identification units 414 and 424 are achieved by the Near Field Communication (NEC) technology, the identification unit 414 may be a NFC Tag, and the identification unit 424 ma be a NFC Reader. When the identification units 414 and 424 are achieved by the Bluetooth technology, the identification unit 414 may be a Bluetooth transmitter, the identification unit 424 may be a Bluetooth receiver. The identification units 414 and 424 are integrated to the Bluetooth units 416, 426.

In the embodiment, the identification unit of the host and the identification unit of the mobile device identify each other, and the wireless connection is built, whether to identify before the wireless connection can be determined by the mechanism of the Bluetooth connection according to practical requirements, which is not limited herein.

After the wireless connection WC is built between the host 410 and the mobile device 420, the host 410 can wirelessly transfer the image data IS to the mobile device 420 via Bluetooth connection BC with the mirroring technology, and then the image data IS can be displayed at the mobile device 420.

The mobile device 420 also can transmit the wireless control signal CS to the host 410 via the back channel technology according to the wireless control signal CS generated by the touch input at the mobile device 420, the host 410 receives the wireless control signal CS and operates according to the wireless control signal CS.

In an embodiment, the host 410 further includes a power supply unit 418. The power supply unit 418 wirelessly charges the mobile device 420 when the host 410 is wirelessly connected or matches with the mobile device 420. The wireless charging can be executed independently, or it is executed when the Bluetooth connection BC is maintained between the host 410 and the mobile device 420 and the image and/or audio data is transferred.

When the mobile device 420 gets close to the host 410, the identification unit 414 outputs the Bluetooth connection information BCI to the identification unit 424, and then the mobile device 420 gets the needed information for the Bluetooth connection BC to connect to the host 410. At the time, the video/audio information can be transferred between the host 410 and the mobile device 420 via the Bluetooth connection BC (for example, the mobile device 420 operates the host 410 to play audio/video the back channel technology).

In this embodiment, the video/audio information can be transferred between the host 410 and the mobile device 420 via the Bluetooth connection BC, however, in consideration of that the bandwidth of the Bluetooth is too narrow and thus the image transmission may be not good, the Bluetooth connection BC between the host 410 and the mobile device 420 are mainly used for transferring audio information.

For example, when the mobile device 420 gets dose to the host 410, the host 410 identifies the mobile device 420 to build Bluetooth connection BC therebetween. At the time, a user can touch a music icon at the mobile device 420 to make the host 410 play the music. Moreover, the volume of the music can be adjusted via the GUI when the host 410 or the mobile device 420 plays the music.

In sum, according to the vehicle system in embodiments, images received or stored by a host are displayed at the mobile device which can be detachably connected to the host via wireless connection or the Bluetooth connection, and the host is controlled by the GUI at the touch panel of the mobile device.

When the mobile device is not connected to the host, the vehicle system only has the basic function of the host (such as music play or radio function). When the mobile device is connected to the host via the wireless connection, the vehicle system can display the image data from the host via the touch panel of the mobile device. That is, when the mobile device is connected to the host via the wireless connection, the vehicle system has the display function.

The mobile device can be detached from or connected with the host freely, that is, the mobile device can operate independently or cooperate with the host.

Additionally, the display function is executed via the mobile device which is independent from the host, and thus the touch screen conforming to the car does not need to be built in the host, and then the cost of the vehicle system can be reduced.

Although the present invention has been described in considerable detail with reference to certain preferred embodiments thereof. the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An operation method of a vehicle system, wherein the vehicle system includes a host and cooperates with a mobile device, the method comprising:
connecting the mobile device and the host wirelessly, wherein the mobile device is detachably connected to the host;
receiving a touch input at the mobile device to generate a wireless control signal;
receiving the wireless control signal at the host to make the host operate according to the wireless control signal;
transmitting an image data to the mobile device wirelessly; and
displaying the image data at the mobile device.

2. The operation method according to claim 1, wherein the host identifies the mobile device before the step of connecting the mobile device and the host wirelessly.

3. The operation method according to claim 2, wherein after the host identifies the mobile device, wireless connection information is wirelessly transferred to the mobile device to build wireless connection between the host and the mobile device according to the wireless connection information.

4. The operation method according to claim 3, wherein the wireless connection information includes one or a combination of Bluetooth connection information and WiFi connection information.

5. The operation method according to claim 1, wherein the host wirelessly charges the mobile device when the host is connected to the mobile device.

6. The operation method according to claim 2, wherein the identification is achieved by Near Field Communication (NFC) technology or Bluetooth.

7. The operation method according to claim 1, wherein the touch input is generated by operating a Graphic User Interface (GUI).
